(19) United States
(12) Patent Application Publication
(10) Pub. No.: US 2013/0289945 A1
(43) Pub. Date: Oct. 31, 2013

(54) System and Method for Space Utilization Optimization and Visualization

(71) Applicants: William B. Ball, Seaford, VA (US); Robert L. Gage, Yorktown, VA (US); Raymond L. Gates, Virginia Beach, VA (US)

(72) Inventors: William B. Ball, Seaford, VA (US); Robert L. Gage, Yorktown, VA (US); Raymond L. Gates, Virginia Beach, VA (US)

(73) Assignee: U.S.A. as represented by the Administrator of the National Aeronautics and Space Administration, Washington, DC (US)

(21) Appl. No.: 13/457,540

(22) Filed: Apr. 27, 2012

(51) Int. Cl. G06F 17/50

(52) U.S. Cl. 703/1

(57) ABSTRACT

Embodiments of the invention may provide the ability for infrastructure managers to readily assess current organizational space allocation, to determine overcrowded and/or underutilized facilities, to propose options for improving and/or optimizing space usage in a facility, and to visualize current and proposed utilization. Embodiments of the invention may also provide the ability to reduce operational costs by more efficiently utilizing available space. Embodiments of the invention may comprise optimization algorithms to help redistribute organizational slots based on a variety of user-defined criteria (e.g., lab/technical space constraints, organizational synergy constraints, move minimizations, etc.).

### STATEMENT REGARDING FEDERALLY SPONSORED RESEARCH OR DEVELOPMENT

The invention described herein was made in part by an employee of the United States Government, and may be manufactured and used by or for the Government for Government purposes without the payment of any royalties thereon or therefore.

### FIELD OF THE INVENTION

The present invention relates to space optimization.

### BACKGROUND

Federal and State organizations, as with much of the corporate world, continue to experience pressure to undergo major downsizing and reorganization. The stimulus for these includes alterations in mission requirements, the introduction of full-cost accounting methods, funding cuts, and the excessive operational and maintenance costs associated with aging infrastructure. A need exists for a strategic capability to support more effective and efficient facility management through the use of Geographic Information System (GIS) and optimization technologies.

### BRIEF SUMMARY

In one embodiment of the invention, a computer-implemented method for generating a spatially constrained tree map diagram comprises: (i) organizing features from a data set into a binary tree representation comprising a plurality of nodes, each node being either (a) a leaf node representing a feature in a lowest level data set or (b) a non-leaf node containing a reference to two child nodes, a top-most node having a definition of a convex polygon that will contain the entire spatial tree map diagram, each node containing a quantity to be represented by an area of a corresponding polygon and for non-leaf nodes this quantity being the sum of the two contained child nodes, each node further containing a direction in which that node's polygon should be split by a straight line to generate polygons for the child nodes, each non-leaf node being constrained such that the set of spatial features corresponding to the sub-tree rooted at that node can be split into two groups using a single line oriented in a similar direction to the line used to split the node's polygon in the diagram and such that these two groups correspond to the sub-trees rooted at each of the child nodes; (ii) starting at the top-most node and recursively processing each of the child nodes in turn by: (a) for each, non-leaf node, generating two polygons by cutting the original polygon along the direction indicated such that the ratio of the areas of the two generated polygons is the same as the ratio of the quantitative metric stored in the child nodes; and (b) storing each generated polygon in the corresponding child node; and (iii) reading the generated polygons at each node from the tree.

The direction in which each node's polygon should be split may be either along a vertical or a horizontal direction.

The direction in which each node's polygon should be split and/or the location of the split may be selected to maximize the gap distance between the closest features associated with the child nodes of a particular node.

The direction in which each, node's polygon should be split and/or the location of the split may be selected to balance the total metric quantities in each child node of a particular node.

The direction in which each node's polygon should be split and/or the location of the split may be selected to balance the center of mass of the child nodes' associated spatial features along a direction opposite to the splitting direction defined for the parent node.

The direction in which each node's polygon should be split and/or the location of the split may be selected to generate a polygon having a reduced aspect.

Features from a data set may be organized into a binary tree representation using (i) a top-down recursive generation method, (ii) a top-down recursive generation method with back tracking, (iii) a bottom-up generation method comprising construction of sub-trees based on proximity based clustering, (iv) a random construction method, or any of (i), (ii), (iii), or (iv) combined with one or more optimization techniques.

In addition to the method of generating a spatially constrained tree map diagram, as described above, other aspects of the present invention are directed to corresponding systems and computer program products for generating a spatially constrained tree map diagram.

In another embodiment of the invention, a method for optimizing usage of space in a facility comprises (a) obtaining a current space allocation; (b) solving the current space allocation for constraint violations; (c) applying a greedy heuristic to the current space allocation to obtain a first lower cost space allocation without violating any constraints; (d) saving the first lower cost space allocation as a best space allocation; (e) generating a first random space allocation; (f) saving the first random space allocation as the current space allocation; (g) solving the first random space allocation for constraint violations; (h) applying a greedy heuristic to the first random space allocation to obtain a second lower cost space allocation without violating any constraints; (i) comparing a cost of the second lower cost space allocation to a cost of the best space allocation; and (j) if the cost of the second lower cost space allocation is less than the cost of the best space allocation, saving the second lower cost space allocation as the best space allocation.

If the cost of the second lower cost space allocation is not less than the cost of the best space allocation, the method may further comprise (k) generating a second random space allocation; (l) saving the second random space allocation as the current space allocation; (m) solving the second random space allocation for constraint violations; (n) applying a greedy heuristic to the second random space allocation to obtain a third lower cost space allocation without violating any constraints; (o) comparing a cost of the third lower cost space allocation to a cost of the best space allocation; and (p) if the cost of the third lower cost space allocation is less than the cost of the best space allocation, saving the third lower cost space allocation as the best space allocation.

If the cost of the second lower cost space allocation is not less than the cost of the best space allocation, the method may further comprise (k) comparing, for each consumer of a space, a cost allocation from the best space allocation to a cost allocation from the second lower cost space allocation to determine a lower cost space allocation for each consumer; (l) merging the lower cost space allocations for each consumer and saving the lower cost space allocations for each consumer as the current space allocation; (m) solving the current space allocation for constraint violations; (n) applying a greedy heuristic to the current space allocation to obtain a third lower cost space allocation without violating any constraints; (o) comparing a cost of the third lower cost space allocation to a cost of the best space allocation; and (p) if the cost of the third lower cost space allocation is less than the cost of the best space allocation; saving the third lower cost space allocation as the best space allocation.

If the cost of the third lower cost space allocation is not less than the cost of the best space allocation, the method may further comprise (q) comparing, for each consumer of a space, a cost allocation from the best space allocation to a cost allocation from the third lower cost space allocation to determine a lower cost space allocation for each consumer; (r) merging the lower cost space allocations for each consumer and saving the lower cost space allocations for each consumer as the current space allocation; (s) solving the Current space allocation for constraint violations; (t) applying a greedy heuristic to the current space allocation to obtain a fourth lower cost space allocation without violating any constraints; (u) comparing a cost of the fourth lower cost space allocation to a cost of the best space allocation; and (v) if the cost of the fourth lower cost space allocation is less than the cost of the best space allocation, saving the fourth lower cost space allocation as the best space allocation.

Applying the greedy heuristic may comprise (i) identifying a current consumer; (ii) identifying a space closest to the current consumer; (iii) determining if moving the current consumer into the identified space will, reduce a cost metric of the current consumer; (iv) if moving the current consumer into the identified space will reduce a cost metric of the current consumer, moving the current consumer into the identified space; (v) if moving the current consumer into the identified space will not reduce a cost metric of the current consumer, determining if swapping the current consumer with a consumer in the identified space will reduce the cost metric of the current consumer; (vi) if swapping the current consumer with a consumer in the identified space will reduce the cost metric of the current consumer, swapping the current consumer with a consumer in the identified space; and (vii) if swapping the current consumer with a consumer in the identified space will not reduce the cost metric of the current consumer, identifying a next-closest space to the current consumer and repeating steps (iii) to (vi) for the next-closest space.

In addition to the method of optimizing usage of space in a facility, as described above, other aspects of the present invention are directed to corresponding systems and computer program products for optimizing usage of space in a facility.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a standard floor plan in accordance with known prior art.

FIG. 2 is a standard floor plan in which space to be optimized is identified, in accordance with embodiments of the present invention.

FIG. 3 illustrates a spatially constrained treemap diagram for the building illustrated in FIG. 2, in accordance with embodiments of the present invention.

FIG. 4 illustrates a spatially constrained treemap diagram for a plurality of buildings, in accordance with embodiments of the present invention.

FIGS. 5-11 are flowcharts of a method of optimizing usage of space in a facility, in accordance with embodiments of the present invention.

FIG. 12 is a schematic block diagram of a computer network in which embodiments of the present invention may operate.

FIG. 13 is a schematic block diagram of a computer in the network of FIG. 12.

### DETAILED DESCRIPTION

Embodiments of the invention may provide the ability for infrastructure managers to readily assess current organizational space allocation, to determine overcrowded and/or underutilized facilities, to propose options for improving and/or optimizing space usage in a facility, and to visualize current and proposed utilization. Embodiments of the invention may provide the ability to reduce operational costs by more efficiently utilizing available space. Embodiments of the invention may comprise optimization algorithms to help redistribute organizational slots based on a variety of user-defined criteria (e.g., lab/technical space constraints, organizational synergy constraints, move minimizations, etc.).

Embodiments of the invention may use Geographic Information System (GIS) software (e.g., ArcGIS by ESRI, Inc.) coupled with custom code to enable space utilization managers to construct and evaluate various “what-if” move-planning scenarios. Embodiments of the invention may enable interactive manipulation of organizational slots both within buildings and between buildings while displaying space utilization parameters (e.g., over/under capacity) in real time. Coupled with the optimization algorithm, embodiments of the invention may enable space utilization managers to rapidly evaluate proposed scenarios. Embodiments of the invention may enable space utilization managers to add constraints such as room or personnel “lock down,” after which the remaining space can be optimized.

### Space Utilization Optimization Process and Tools

Space allocation planning is a complex problem involving the allocation of limited resources to meet business goals, reduce operating costs, and promote an effective and productive workplace. The optimization process has many facets and is very complex. Embodiments of the invention may comprise various modules, such as visualization, optimization, data maintenance, web interface, technical space, etc.

### Visualization

Visualizing data related to geographically sparse features is a challenging task. While presentation in traditional map form can preserve the spatial relationships between features, there is a significant amount of unused space in the visual representation, limiting the quantity of data that may be usefully shown. Similarly, data can be densely represented graphically using traditional diagramming techniques such as treemaps, but the spatial relationships are lost. Additionally, it may be desirable to present spatial data combined with non-spatial data or present multiple spatial data sets that may exist in differing coordinate systems where there is a natural hierarchical relationship linking the data sets. Examples of this include data describing facilities where one data set may represent global facility locations, another may represent the locations of building structures within each of those facilities, another may represent the locations of floors and rooms within those buildings in traditional floorplan drawings, and another may represent the equipment locations by room as a simple table. In such cases, it is desirable to represent the lower level data as graphically contained within (or as a subdivision of) the related higher-level feature.

The data presented may have a quantitative metric such as area in square feet or maintenance cost in dollars, where the relative amounts of this metric are of strong importance. In such cases, it may be desirable to represent this metric graphically by preserving the relative quantities of a set of features as the relative areas of the polygons representing those features. In the case of combining multiple hierarchically related data sets, the areas of the polygons representing the higher-level feature should reflect the sum of the underlying metric in the related lower level features. For example, the relative sizes of two polygons representing buildings could reflect the ratio of the total areas of all the rooms shown within each building.

To aid in visual interpretation, it is also desirable for the polygons generated to have the smallest possible aspect, defined as the ratio of largest distance between any two points within the polygon to the area of the polygon. This property is important to visual interpretation because it becomes more difficult for a person to accurately judge the relative areas of two polygons as the polygons become elongated.

As indicated previously, data sets of the types indicated previously usually have a natural hierarchy where each feature in the higher-level data set represents one or more features in the lower level data set. It is desirable to preserve this natural hierarchy in any generated diagrammatic representation.

Traditional treemap diagrams possess the desirable property of generating polygons that can represent such a quantitative metric as described and can be constrained to represent the natural hierarchies in the data sets, but existing techniques for generating them cannot preserve the spatial relationships between those features beyond any naturally defined hierarchy. The approach defined by embodiments of the present invention is to impose additional constraints on the generation of a treemap diagram such that aspects of the spatial relationships are preserved.

Embodiments of the invention may comprise a user interface that employs a dashboard concept which will allow the user to access any or all data representations such as a spatially constrained treemap diagram, a plant level map, building interior layout, and any desired supporting tabular data. Embodiments of the invention may enable consumers of solutions to readily see relative size and proximity of buildings, rooms, and personnel for an entire facility. Additionally, embodiments of the invention may use any symbolization and labeling available through the GIS software used in creating embodiments of the invention. For more detailed analysis, additional conventional map views and building layouts with room details may be available. The user may be able to visualize current conditions and various proposed optimization solutions and manually adjust conditions through tools such as drag and drop.

To address plant level visualization, embodiments of the invention may comprise a visualization tool termed a spatially constrained treemap diagram. This diagramming technique uses an abstract representation of all (or, optionally, some) buildings in a facility compressed into a convex polygon. Since the focus is on space utilization, features such as roads, parking lots, grass, etc., are typically not addressed in the data-viewing tool. The diagram capability maximizes any view window for the data under consideration. The tool effectively eliminates white space (distance between buildings) on a drawing by compression and proportioning the data.

Convex polygons (e.g., rectangles) represent each of the facility's buildings. The polygons for each building are roughly oriented based on proximity to other buildings around them. The size of the polygon represents usable space within the building. The polygon that represents a building can be further subdivided to show all rooms, or more typically all usable rooms (i.e., excluding utility rooms, storage rooms, etc.). As in the buildings, the rooms are represented by polygons (e.g., rectangles). Again, the size of each room polygon is proportional and its relative position to the real world location is maintained. Multiple floors of buildings may be delineated with lines (e.g., shadow lines). There are many areas in a building such as circulation areas, stairwells, bathrooms, mechanical equipment rooms, etc., which may not be germane to a space allocation problem and thus need not be included for analysis via the visualization tool.

Symbolization may be applied to the polygons for buildings and rooms to show those spaces that are appropriate for general office use and technical areas (e.g., labs), each of which may be symbolized based on the owning organization. Colors may be used, for example, such that the closeness in color may be indicative of the closeness of the organizations in the organizational hierarchy. A similar scheme may be used to color the point features, which indicate the personnel at the facility. Embodiments of the invention may use these techniques to visualize not only area but also any commodity or value, such as maintenance cost where size could represent cost. One possible goal for optimum synergy would be to have similar colors in close proximity. The spatially constrained treemap diagram provides a dense and concise visualization allowing user interaction with the massive and diverse data associated with managing a complex facilities space. The spatially constrained treemap diagram approach can be extended to illustrate each person's space at the facility. Thus from one interface or data view, the user can interact with data for the entire facility that represents either building level, room level, or personnel level data.

In one embodiment of this invention, the initial polygon and all generated polygons are convex in nature and the subdivision of each polygon is by an arbitrarily oriented straight line that divides the original convex polygon into exactly two new convex polygons. In the generation of such treemaps, the process can be generally defined as organizing the features from the data sets into a binary tree representation where each node in the tree may represent a feature in the lowest level data set (a leaf of the tree) or may contain a reference to exactly two other nodes in the tree (child nodes). The top-most node in the tree is given a definition of a convex polygon that will contain the entire diagram. In addition, each node stores the quantity to be represented by the area of the polygon (and for non-leaf nodes this quantity is the sum of the two contained nodes) and the direction on which that node's polygon should be split by a straight line to generate the polygons for the child nodes. Any such organization obeys the natural hierarchies in the data sets such that all nodes representing any related lower level features fall under the node representing the higher-level feature.

Once such an organization is achieved, generation of the diagram proceeds in a straight forward manner by starting at the top-most node and recursively processing each of the child nodes in turn. For each non-leaf node, two polygons are generated by simply cutting the original polygon along the direction indicated such that the ratio of the areas of those polygons is the same as the ratio of the quantitative metric stored in the child nodes. Each polygon is subsequently stored in the appropriate child node and each child is then processed recursively. The polygons stored at the nodes in the tree may then be read from the tree and stored. In many cases, it is useful to store the polygons at the leaf nodes and the polygons stored at other nodes corresponding to the natural'hierarchies from the data sets.

Organizing the features from the data sets into such a tree representation is key to obtaining a diagram with the desired properties. In the generation of traditional treemap diagrams, the focus is on minimizing the aspect (as defined earlier). The additional focus here is on preserving some spatial properties of the spatial features in the treemap representation. In particular, embodiments of the invention constrain each non-leaf node such that the set of spatial features corresponding to the sub-tree rooted at that node can be split into two groups using a single line oriented in a similar direction to the line used to split the node's polygon in the diagram and such that these two groups correspond to the sub-trees rooted at each of the child nodes. In one embodiment of this invention, the cutting lines are additionally constrained to be along vertical or horizontal directions. In this case, assuming the initial polygon is a rectangle, all generated polygons will also be rectangles and all rectangles falling to the left of a common splitting edge in the diagram will correspond to spatial features to the west of all features corresponding to the rectangles on the right of the common splitting edge. Because this spatial constraint is, applied recursively at all nodes in the tree, the relative orientation of the spatial features is preserved in the diagram. Note that for a particular number N of features, there are N−1 ways to split those features along a single direction and the direction of the split can be varied at every node providing significant freedom in the choice of tree organization.

To further improve the representation of the spatial relationships, certain splitting directions and choice of split position among the N−1 possibilities can be preferred by a generating algorithm based on various desirable properties. Preferences may be based on many considerations including, but not limited to, maximizing the gap distance between the closest points on each side, balancing the total metric quantities (and thus the polygon areas) on each side, or balancing the center of mass of the spatial features along a direction opposite to the splitting direction. The last property tends to avoid shearing along major divisions corresponding to nodes nearer the root node, which, if not considered, could result in polygons on opposite sides of the major division being close together while the corresponding spatial features may be significantly distant from each other or vice versa. Additionally, any such implementation may prefer polygons with lower aspect (as defined earlier) over those with higher aspect as in traditional treemap diagrams.

Generating algorithms may use any of a variety of means to organize the features into a tree representation meeting the constraints defined above (and using any or none of the preferential properties defined) including, but not limited to, top-down recursive generation, top-down recursive generation with back tracking (for instance when any of the properties exceeds some defined limits), bottom-up generation by construction of sub-trees based on proximity based clustering, random construction, and any of the previous methods combined with optimization techniques designed to improve the defined properties.

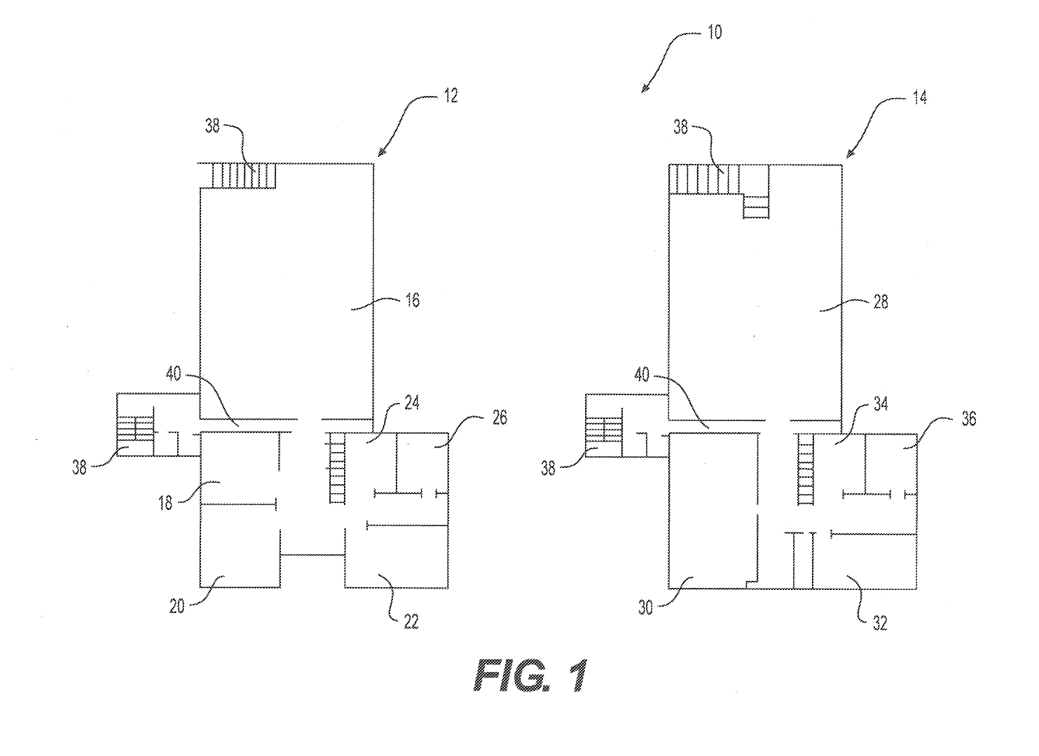

Referring now to FIGS. 1-3, the creation of a spatially constrained treemap diagram for one building is illustrated. FIG. 1 is a standard floor plan in accordance with the standard manner of representing floor plans. Floor plan 10 comprises separate floor plans for the first floor 12 and the second floor 14. First floor plan 12 comprises a technical area (e.g., lab) 16, offices 18, 20, 22, 24, and 26, stairwells 38 and hallway 40. Second floorplan 14 comprises technical areas (e.g., labs) 28 and 30, offices 32, 34, and 36, stairwells 38 and hallway 40.

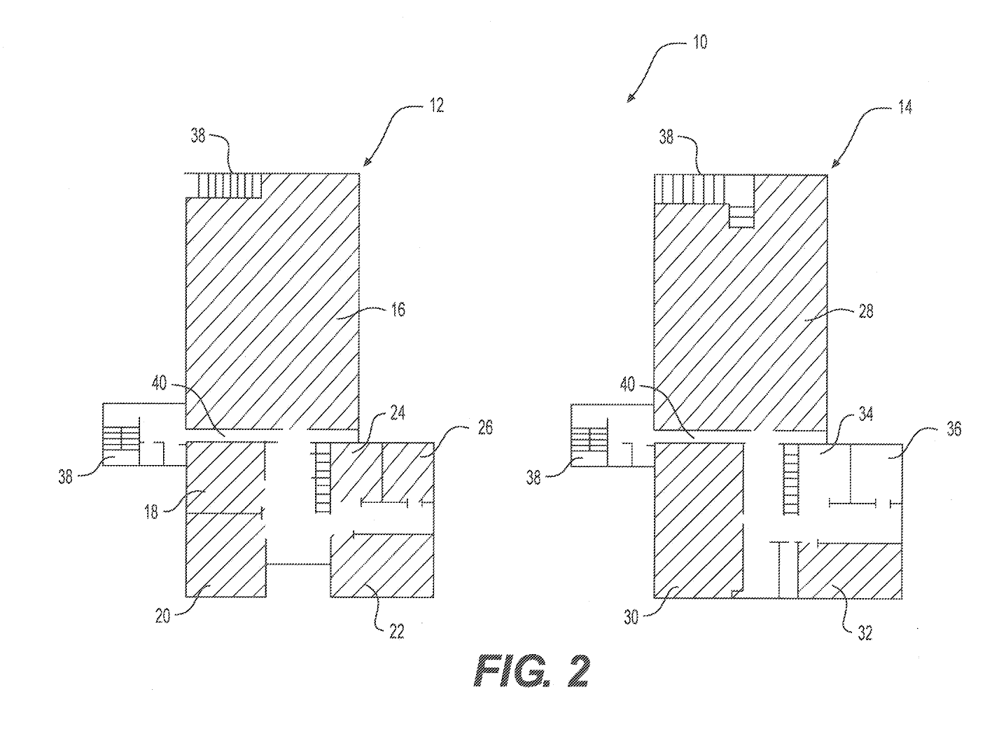

A typical first step in creating a spatially constrained treemap diagram is to identify the workspaces and non-work spaces in a building (i.e., to differentiate the workspaces from the non-work spaces). The workspaces may then be identified by type of space, such as office space or technical space. This is illustrated in FIG. 2 in which spaces to be optimized are identified with hatching. While FIG. 2 is illustrative of the step of identifying work and non-work spaces, it is not necessary to create such an illustration as long as the identifying step is performed. The relative area of each workspace is determined, along with the position of each workspace relative to the other workspaces.

This information may then be used to create a spatially constrained treemap diagram in which each of the workspaces is depicted as a polygon whose relative size corresponds to the relative area of the corresponding workspace. All of the polygons for all of the workspaces in a building may be combined into a combined building polygon, maintaining the relative positions of each workspace polygon based on the real world relative positions of the workspaces, in the building. For a multi-floor building, all of the polygons for all of the workspaces on each floor may be combined into respective combined floor polygons. All of the floor polygons may then be combined into a combined building'polygon.

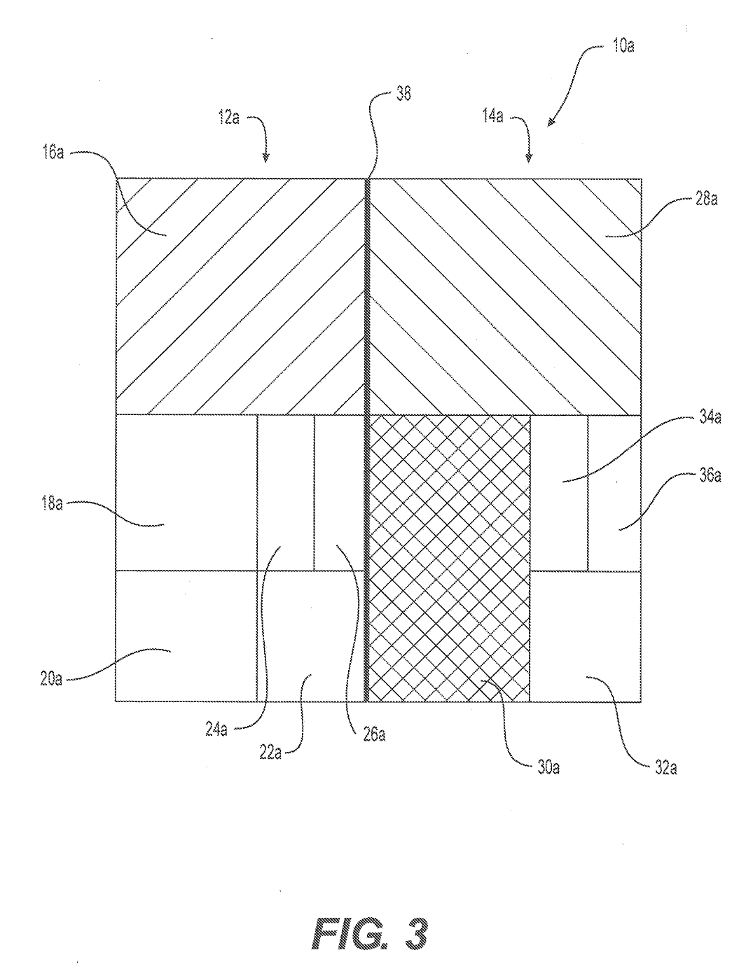

FIG. 3 illustrates a spatially constrained treemap diagram for the building illustrated in FIGS. 1 and 2, in accordance with embodiments of the present invention. Spatially constrained treemap diagram 10a depicts both floors of the building of FIGS. 1 and 2—first floor 12a and second floor 14a. As seen in FIG. 3, the entire building diagram (i.e., both floors) is depicted by a rectangle (i.e., polygon), and each floor is depicted by a rectangle. The rectangles for the first and second floors are separated by a bold line 38 or any other suitable method of demarcation. FIG. 3 comprises rectangle 16a representing first floor technical area 16 and rectangles 18a, 20a, 22a, 24a, and 26a representing first floor offices 18, 20, 22, 24, and 26 respectively. FIG. 3 further comprises rectangles 28a and 30a representing second floor technical areas 28 and 30 respectively and rectangles 32a, 34a, and 36a representing second floor offices 32, 34, and 36 respectively. Non-work spaces, such as stairwells 38 and hallway 40, are omitted from the spatially constrained treemap diagram 10a of FIG. 3.

Technical areas 16a, 28a, and 30a are differently hatched to illustrate different owning organizations. Hatching is used in FIG. 3 to illustrate such ownership in a black and white drawing; however, actual implementations of embodiments of the invention would typically use different colors (and shades of colors) to indicate ownership.

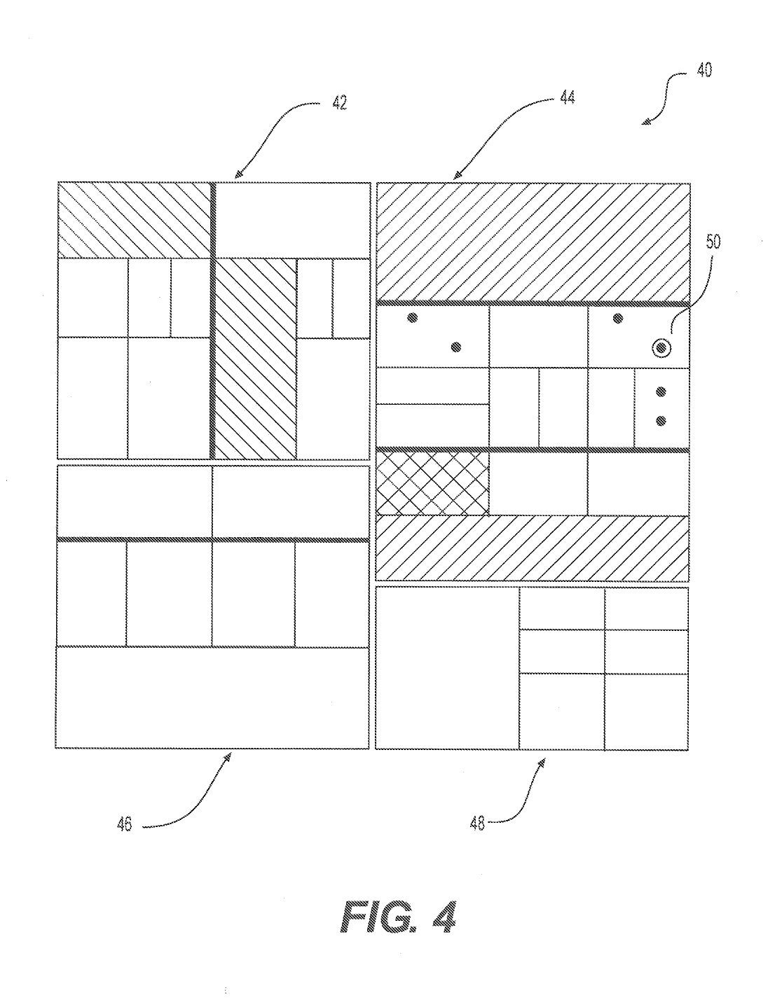

The creation of a building spatially constrained treemap diagram as illustrated in FIG. 3 may be repeated for additional buildings in a facility. In such a facility spatially constrained treemap diagram, the position of each building relative to the other buildings is maintained. FIG. 4 illustrates a spatially constrained treemap diagram for a plurality of buildings, in accordance with embodiments of the present invention. While FIG. 4 illustrates a spatially constrained treemap diagram for four buildings for simplicity, a spatially constrained treemap diagram for a real world facility may comprise dozens or even hundreds of buildings. The spatially constrained treemap diagram 40 of FIG. 4 comprises four building spatially constrained treemap diagrams 42, 44, 46 and 48. Building spatially constrained treemap diagram 42 illustrates a two-story building. The first floor comprises one technical space and five office spaces. The second floor comprises two technical spaces and three office spaces. Building spatially constrained treemap diagram 44 illustrates a three-story building. The first floor comprises one technical space. The second floor comprises nine office spaces. The third floor comprises two technical spaces and two office spaces. Building spatially constrained treemap diagram 46 illustrates a two-story building. The first floor comprises one technical space and one office space. The second floor comprises one technical space and four office spaces. Building spatially constrained treemap diagram 48 illustrates a one story building comprising one technical space and six office spaces. As in FIG. 3, the different hatching in FIG. 4 illustrates different organizational ownership of the technical spaces.

FIG. 4 comprises six point features, which illustrate personnel assigned to office and/or technical spaces (either in a current or a proposed space allocation). While FIG. 4 illustrates only six personnel for simplicity, a spatially constrained treemap diagram for a real world facility may comprise dozens, hundreds, or even thousands of personnel. FIG. 4 illustrates the point features in black due to the limitations of a black and white drawing; however, actual implementations of embodiments of the invention would typically use different colors (and shades of colors) to indicate each person's position in an organizational hierarchy. While FIG. 4 illustrates personnel using a point feature, any other desired symbology may be used.

The point features are illustrated within the office or technical space to which its respective personnel are assigned. FIG. 4 illustrates six personnel in three office spaces. The point feature (or other symbol) may be modified to illustrate that a person's assignment to a particular space violates one or more predefined constraints related to the person and/or the workspace (constraints are described in more detail below). In FIG. 4, one point feature is illustrated with a surrounding circle or halo to indicate a constraint violation. For example, this constraint violation illustrated in FIG. 4 might be that one of the two personnel assigned to space 50 is a manager who is not supposed to share an office with anyone.

The spatially constrained treemap diagrams of FIGS. 3 and 4 can illustrate the current allocation of space or a proposed space allocation plan. A spatially constrained treemap diagram can also be used to modify a displayed space allocation plan. For example, dragging and dropping point features from one space to another space can change the assignment of the personnel accordingly. A constraint indicator (such as the surrounding circle in FIG. 4) can be automatically added or removed if one or more constraints are added or removed, respectively, by the drag-and-drop move. For example, if one of the point features in space 50 of FIG. 4 is dragged and dropped into another space, the circle would be removed because the constraint (that the manager should not be sharing an office) has been resolved. Other space utilization metrics (e.g., over/under capacity) may be displayed and updated in real time as such drag-and-drop moves are made.

### Metrics and Constraints

Due to the complexity of the space utilization-planning-task, it is useful to have a model so that one scenario can be compared to others as one estimates progress toward some goal. That model must address critical variables and effects but be simple enough to make analysis feasible.

Infrastructure-related costs are obvious components to be addressed in the model; less obvious components of a cost model are those that capture the more nebulous effects on performance of a group such as the impact of distance between members of the group on productivity. While it is difficult to assess the true costs associated with the inefficiencies of having personnel distributed over a larger area, the most direct measure is to estimate, the total lost time associated with personnel traveling between offices or between offices and other work areas. This inefficiency translates into the synergy metric components in the cost model.

In order to make the model as flexible as possible, it needs to be as general as possible. The first generalization may be to refer to any person or function that consumes space as a consumer. This could be a laboratory, a conference area, etc. Similarly, both office and technical areas may be simply referred to as space. These spaces provide certain resources that the consumers need. The most common resource is of course area, but additional resources can be modeled like communications jacks, bandwidth, power, environmental impact, etc.

Once all the basic components are in place, it is desirable to evaluate and compare particular allocation plans. It is desirable to determine if an allocation meets predefined rules and/or to compare two valid allocations and determine which one is objectively better. Processing of the optimum placement of consumers in a facility may be governed by “constraints.” These “Go-No Go” parameters may include considerations such as adequate space for the consumer (minimum area for varying types of employee), compatibility with co-located consumers (supervisors/employees not placed in the same room), and compatibility with features that the space readily provides (floor loads, high bay, etc.). Personnel may be assigned to categories, with differing constraint values for each category. For example, personnel may be categorized as “associates,” “managers,” or “senior executives,” with each category having as constraints different minimum and/or maximum size office. Similarly, associates may be allowed or required to share office space, while managers and senior executives would not. Personnel may also be categorized as, for example, civil, servants or contractors, with constraints that prohibit civil servants and contractors from sharing an office.

Further evaluation of the quality of the proposed use of space may be driven by “metrics.” These capture the costs associated with any particular allocation plan as estimated annual efficiency losses. These softer controls address issues such as organizational synergy (the closer personnel are positioned within an organization, the better the metric), move costs, and energy efficiency.

The synergy metric may be measured, for example, by assuming that each person within a group interacts with each other person in the group an assumed number of times per workday, and then assigning a dollar value to each interaction based on the distance between them and an estimated travel speed and salary. All such interactions between every pair of members are considered in calculating the cost. Similarly, if the group is part of a larger group (e.g., a branch within a department), a number of interactions within the smaller group between each member of the smaller group may be assumed and a different (typically smaller) number of interactions between, members of different (sister) groups within the larger group may be assumed. Yet further, certain personnel may be identified as liaisons between groups with an assumed number of interactions between those personnel and the personnel of the groups for which they are liaisons. These groups may be generated automatically from organizational data or defined explicitly.

Similar to the synergy metric, a function synergy metric may measure costs associated with interactions between personnel and stationary functions, such as labs. Costs are computed using the same approach as that specified for the synergy metric, except that the personnel travel to and from the function only based on an estimated usage frequency.

The costs to move personnel to accomplish a proposed utilization scenario may be calculated. In one embodiment of the invention, the lower the move cost the better. The cost may be calculated as, for example, a flat rate per person moved. Alternatively, the cost may vary based on the extent of the move (for example, a move between buildings is more expensive than a move within a building). Move costs are annualized based on projected move frequency.

The costs associated with allocating excessive space to a consumer may be calculated by estimating the inefficiencies such as those associated with energy, e.g. lighting costs per square foot. Each consumer may be assigned a target area, the ideal amount of space needed for that consumer. For any quantity of assigned area over this target, the costs identified here are accrued.

The costs associated with allocating space below the defined target area are intended to capture the inefficiency that would result from the consumer operating in less than ideal conditions. To achieve solutions whose average space per consumer is close to the defined targets, it is necessary to achieve a balance between this cost metric and the synergy cost metrics. In one embodiment of this invention, a cost per square foot is computed by repeatedly performing optimizations while adjusting this value until the consumers average assigned areas converge on the desired targets.

The result is a proposed scenario that meets all constraints and is rated by metrics. The quality of the solution may be expressed in dollars, allowing space utilization personnel to present various solutions to management for consideration. In one embodiment of the invention, the overall cost of a current or proposed space utilization scenario is measured by adding the costs associated with each of the metrics including the move costs, the synergy-related costs, and the costs associated with allocating area above or below the defined targets. The different scenarios will inevitably include manual adjustments to address an organization's political issues, but the metrics and constraints provide feedback on, the impact of those changes to support more objective analysis. Management may then decide if the manually induced change is worth the expenditure to the organization to address the political issue.

### Data Management

As with any system, collecting and maintaining accurate and current data represent challenges for an organization. One problem is that the aforementioned process requires pulling data from many different sources including personnel, GIS, and space utilization databases, with these sources of data constantly changing. The process used to implement an embodiment of the invention is to snapshot the data, resolve any consistency issues, and as needed, reconcile any resulting plan with a current snapshot. Resolving and mapping the source data to a general model manually is very time intensive and involves both data and scenario-specific considerations. It is therefore important to automate this process as much as possible.

An XML (Extensible Markup Language) schema was developed to provide a language for the model. This language is tightly bound to the source code implementation and is reflective of the very general nature of the model. Since virtually every data source has some sort of mapping to an XML schema, the XQuery language was used to perform the data transformation. The result is a “recipe” that addresses the heavy lifting required to arrange or systematize the corporate knowledge.

### Optimization Algorithm

Once a model instance is obtained, it is theoretically possible to manually manipulate allocations and get feedback on the constraints and metrics. Realistically, it is likely necessary to have a computer automatically find an allocation that is in some sense “optimal.” To get a grasp of how big a possible solution might be for a complex facility, consider a small model. A small example that might be considered would be a proposed move involving four people and five rooms. In this example, there are many possible mappings of the consumers to the space. In fact, for this simple problem, there are about a thousand distinct allocations. A computer could easily calculate each of these, throw out the ones that don't meet the constraints, and pick the remaining one that has the lowest composite cost metric.

Should the problem of roughly 4000 people and 4000 spaces be addressed, the resulting number of permutations is enormous. This equates to 10 to the 14,400th power. Obviously, no amount of computational power could ever force an answer via an exhaustive process. What is needed is a method that gives a very good result in a reasonable amount of computational time.

The current optimization approach divides the initial search into two parts. The first part is a constraint solver that takes an allocation, which has violated one or more constraints, and finds a solution in the same neighborhood that satisfies all the constraints. The design provides a framework that is extensible, as the process needs to work for constraints not yet imagined. The second part of the search is a greedy heuristic that takes the most direct route from a given constrained solution to a constrained local optimum. It does this by iterating over a priority queue of consumers and using an efficient local first search. The solution obtained is a local, not a global, optimum.

Optimization is conducted not only from the current condition but also from a random allocation. The results from these processes typically produce good synergy within the smallest organizational units, but many issues may be noted where large scale changes might improve the higher-level synergy and collocation with technical space. What is desirable is to take the good ideas from each and make them fit together. By evaluating the metrics per consumer in each solution, a new solution can be created that tries to combine the best of both. Doing this inevitably results in a solution that doesn't meet the constraints and may not initially look better, but through constraint solving and re-applying the greedy heuristic it is possible to obtain a viable alternative. Combine this with a progressive filtering algorithm, and it is often possible to find improvements to any local optimum. Feeding the process a stream of random solutions enables it to integrate progressively smaller ideas into an improving final solution.

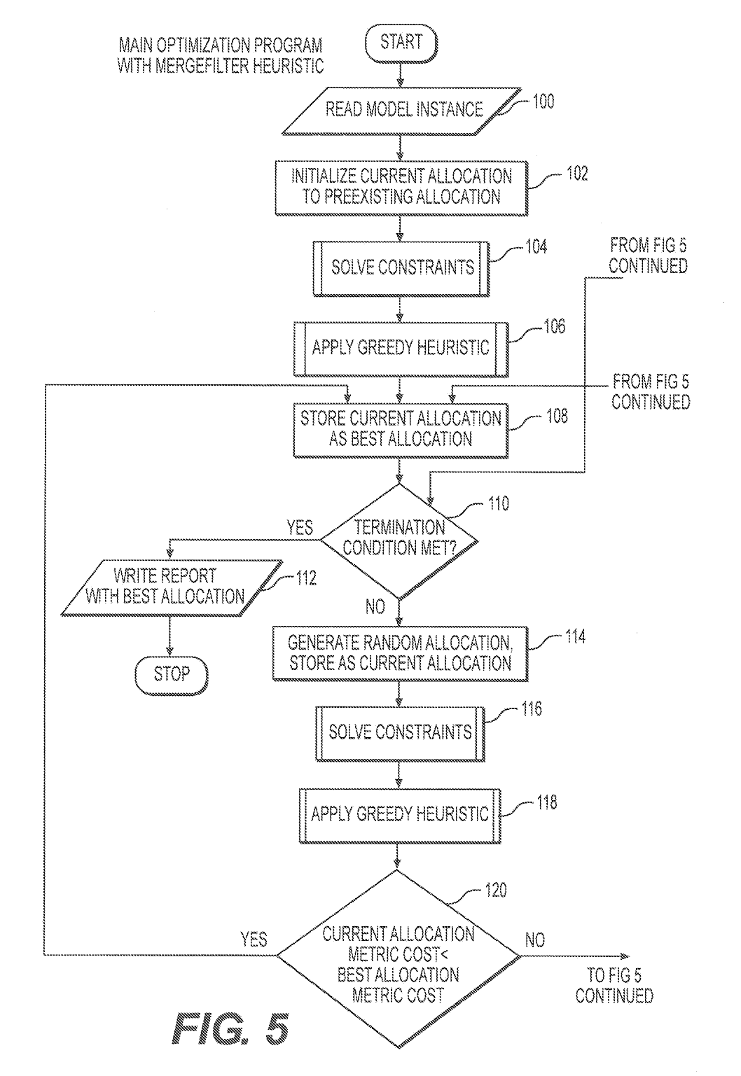

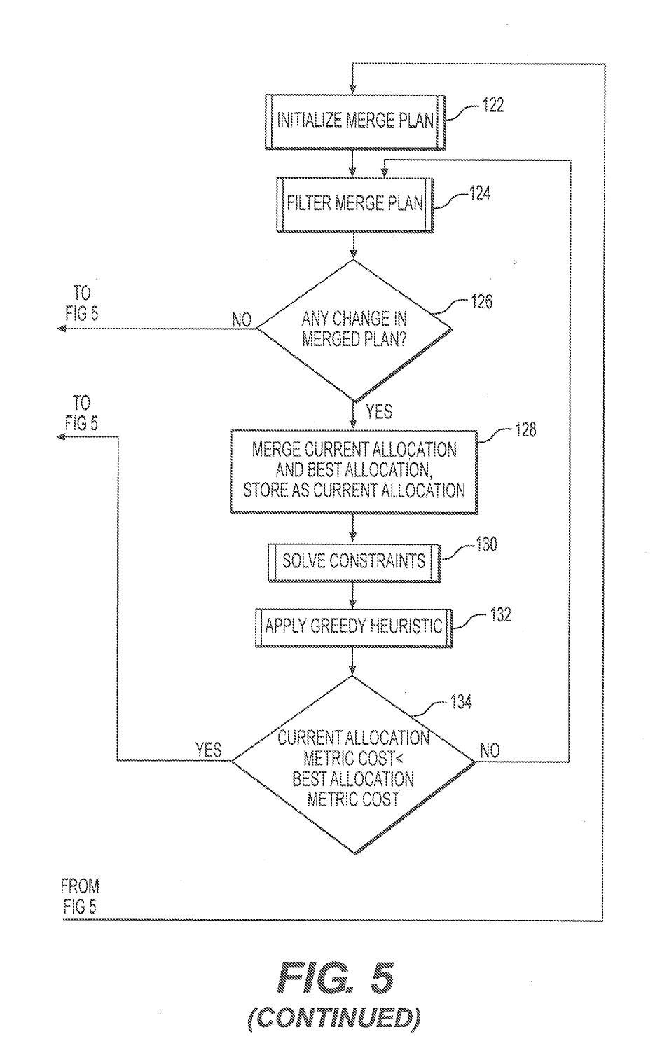

Referring now to FIGS. 5-11, flowcharts of a method of optimizing usage of space in a facility are illustrated in accordance with embodiments of the present invention. FIG. 5 is a flowchart of the main optimization program with a merge-filter heuristic. The model instance is read (block 100). A model instance may be, for example, an XML file that defines a problem domain. For example, the model instance may define consumers, resources, spaces, constraints, and metrics. As discussed above, a consumer may be any person or function that consumes space. These spaces provide certain resources that the consumers need. The most common resource is, of course, area, but additional resources can be modeled like communications, jacks, bandwidth, power, environmental impact, etc. Space pools and groups of consumers may be defined, to define compatibility between spaces and people. For example, there may be a space pool for general employees, one for lower level management, and one for senior management.

Each consumer group typically has a membership list, with roles defined for each person. The consumer groups may define consumer compatibility, by grouping consumers into compatibility pools. For example, managers may be in their own compatibility pool. For the Government, civil servants and contractors may be in separate compatibility pools.

Various constraints may be defined in the model instance. For example, a space compatibility constraint may be used to ensure that consumers are matched to their appropriate space pool. A consumer compatibility constraint may be used to ensure that all consumers in the same space are compatible, such as by ensuring that all people in the same space have at least one consumer group in common. A resource constraint may be used to prevent consuming more resources than are available. Such a resource constraint may be per room, per building, or even per facility.

Various metrics may be defined in the model instance, such as move costs, synergy, office area, and functional synergy. Synergy, move costs, and functional synergy are discussed above. The office area cost metric may be based on the difference between a target office size defined for a particular consumer (typically defined based on the consumer group) and the size of the office to which the consumer is assigned. For example, a particular group of consumers may have a target office size of 120 square feet. If a particular consumer is assigned to a larger office, a penalty may be assigned for the increased energy costs. If a particular consumer is assigned to a smaller office, a penalty may be assigned for the assumed lost efficiency.

A goal of the optimization process is to reduce the cost metric and eliminate constraint violations. It is important to compare costs for each scenario after all constraint violations are eliminated.

The pre-existing space allocation is initialized to be the “current allocation” (block 102). The process calculates the cost metric for the pre-existing allocation by first assuming that everyone is in a “void” (i.e., not allocated anywhere) and then adds them into the current allocation to create a cost basis. Overall costs for the metrics are computed as each consumer is added and the costs are proportioned among the consumers to indicate the contribution of each to the total. The individuals are ranked by contribution (in descending order). The delta costs for allocation changes are typically computed, rather than calculating total costs from scratch after each new allocation is created.

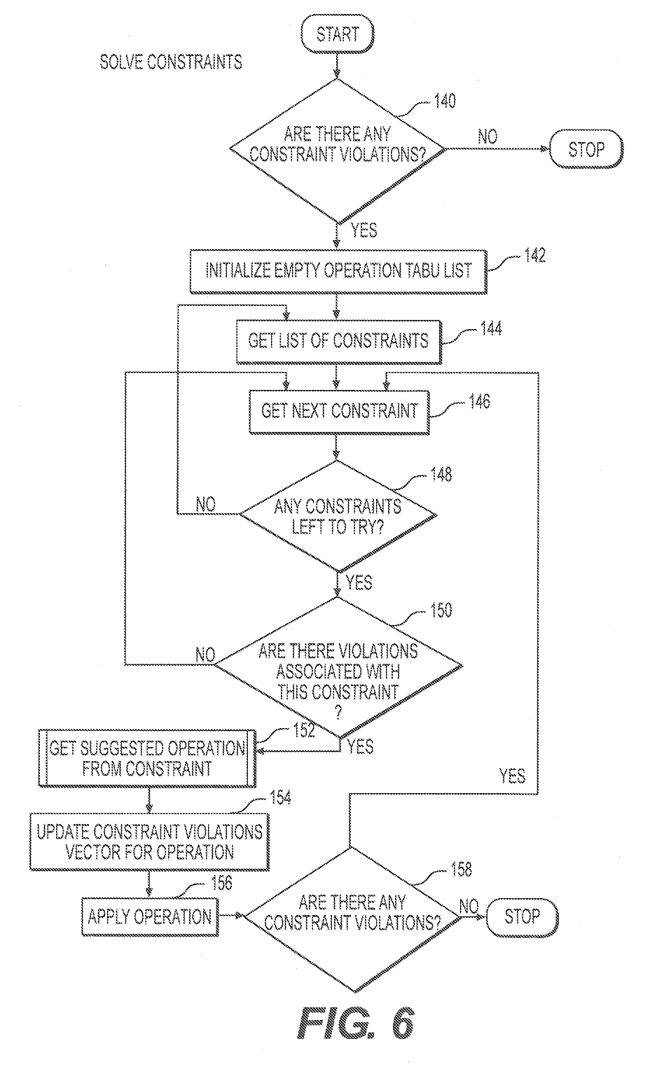

The optimization process then identifies any constraint violations and solves the identified constraint violations (block 104) by executing the “Solve Constraints” process illustrated in FIG. 6 (discussed in more detail below). The constraint solver takes the most direct path to resolution of the constraints.

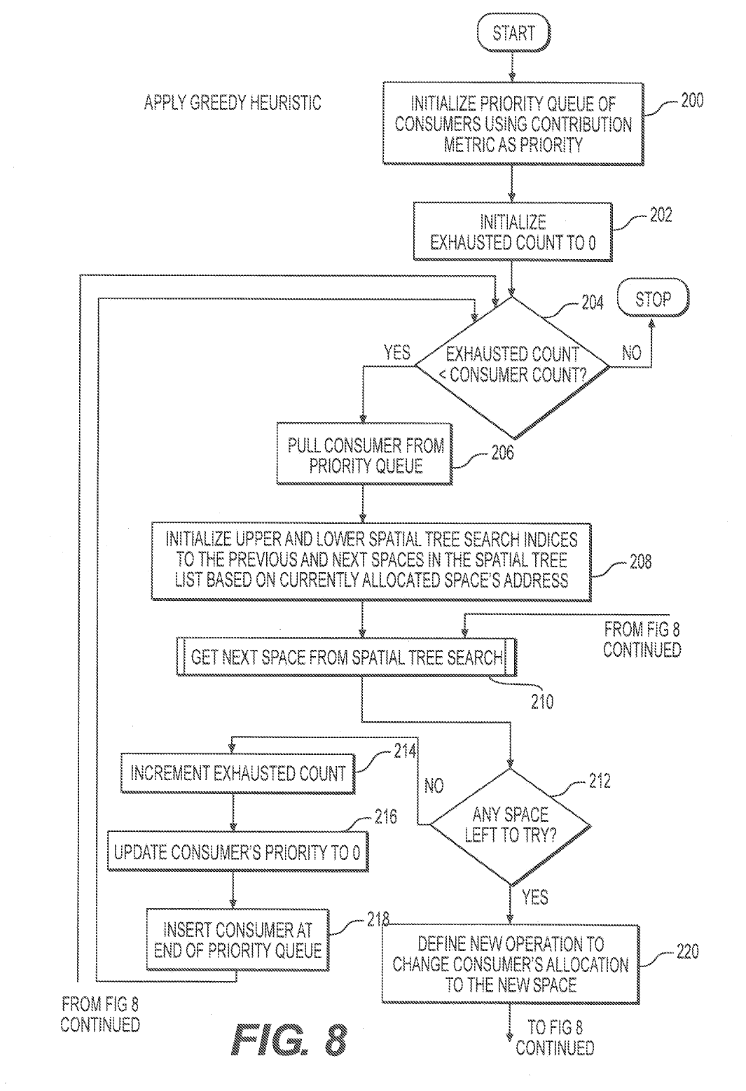

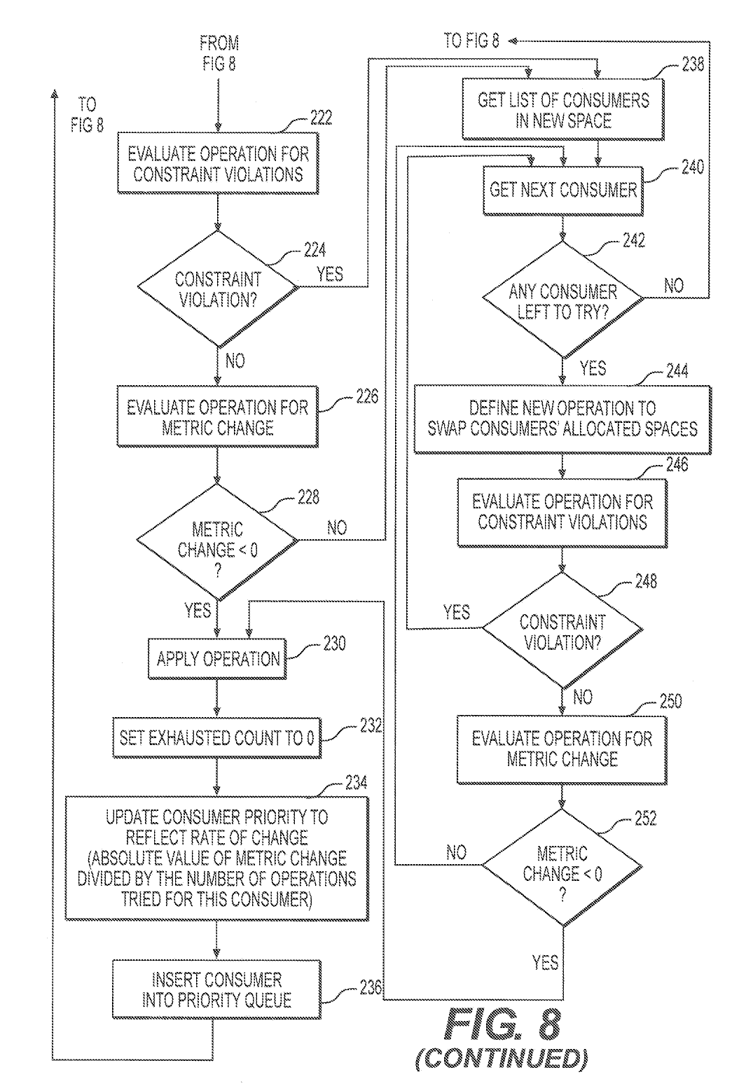

The optimization process then applies a greedy heuristic algorithm (block 106) by executing the “Apply Greedy Heuristic” process illustrated in FIG. 8 (discussed in more detail below). The greedy heuristic algorithm finds the most direct path to a lower-cost space allocation, while not violating any constraints. The solution produced by the greedy heuristic algorithm is a local optimum. A local optimum is obtained when no single operation (either a move of one person or a swap of two people) will improve the solution.

After the current allocation has been solved for constraints and the greedy heuristic algorithm has been applied to obtain a local optimum, the current allocation is saved as the “best” allocation. (block 108). It is then determined if one or more terminal conditions are met (block 110). For example, the terminal condition may be time-based, such that the optimization process terminates after 12 hours. If a terminal condition is met, then the best allocation is reported out (block 112).

If a terminal condition has not yet been met, than a random space allocation is generated and stored as the current allocation (block 114). The random space allocation may, for example, generate a random location assignment for each person. The (new) current allocation (generated randomly) is solved for constraint violations (block 116) and the greedy heuristic algorithm is applied (block 118) (both as described above and as described in detail below in relation to FIGS. 6 and 8). After solving the constraint violations and applying the greedy heuristic algorithm to the (new) current allocation, it is determined whether the cost metric for the (new) current allocation is less than the cost metric for the stored best allocation (block 120). If the cost metric for the (new) current allocation is less than the cost metric for the stored best allocation, then the (new) current allocation is stored as the (new) best allocation and blocks 110-120 are repeated. Blocks 110-120 are repeated until either a terminal condition is met (determined at block 110) or until the cost metric for the (new) current allocation is not less than the cost metric for the stored best allocation (determined at block 120).

If the cost metric for the (new) current allocation is not less than the cost metric for the stored best allocation (which will typically be the case), the merge-filter heuristic is applied (blocks 122-134). The merge-filter heuristic compares each person's allocation from the best allocation and from the current allocation and uses that person's allocation from whichever allocation has the lower contribution to the cost metrics for that person. The merge-filter heuristic typically uses the ranking of each person's contribution to the cost metrics, such that the individuals with the highest contribution are processed first.

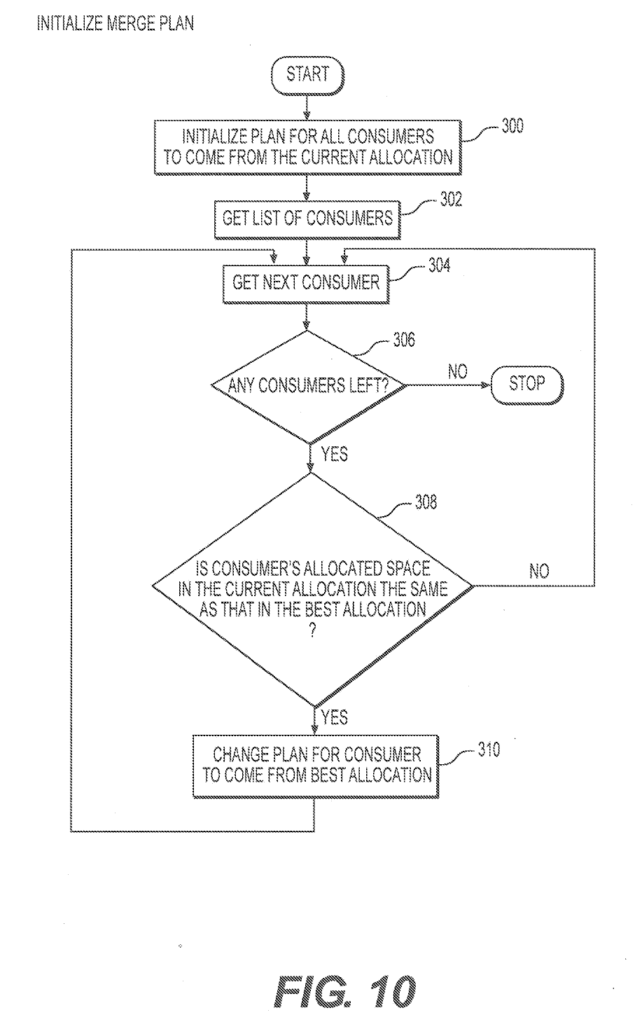

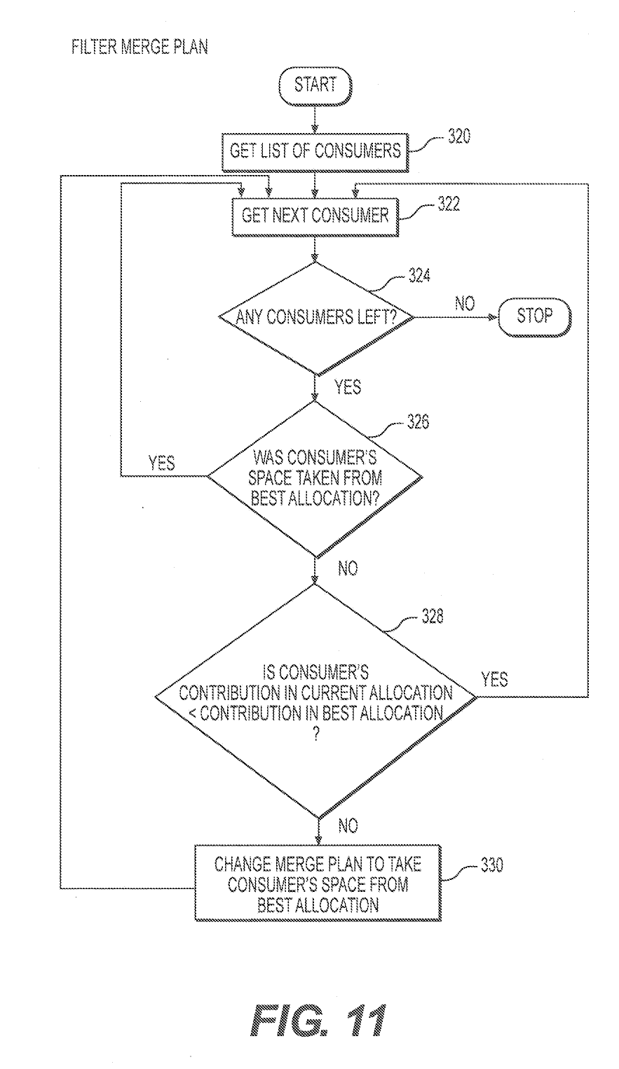

The merge plan is initialized (block 122) to set everyone's allocation as coming from the current allocation. However, if both the current and best allocations for a particular person use the same space, then that person's allocation is set as coming from the best allocation. This is illustrated in FIG. 10 and discussed in more detail below. The merge plan is then filtered, as illustrated in FIG. 11 and discussed in more detail below. Generally speaking, the filtering of the merge plan changes a person's allocation from “current” to “best” if the “best” allocation for that person has a lower contribution to the cost metrics.

It is then determined whether filtering the merge plan resulted in any changes (block 126). That is, did any person's allocation change from “current” to “best”? If not, blocks 110-120 are repeated to generate a new random allocation, solve any constraint violations, and apply the greedy heuristic algorithm. If at least one person's allocation changed from “current” to “best,” then the current allocation and the best allocation are merged by following the merge plan calculated earlier and the merged allocation is stored as the current allocation (block 128). This new current allocation is solved for constraint violations (block 130), and the greedy heuristic algorithm is applied (block 132).

After solving the constraint violations and applying the greedy heuristic algorithm to the (new) current allocation, it is determined whether the cost metric for the (new) current allocation is less than the cost metric for the stored best allocation (block 134). If the cost metric for the (new) current allocation is less than the cost metric for the stored best allocation, then the (new) current allocation is stored as the (new) best allocation. (block 108) and blocks 110-120 are repeated. As before, blocks 110-120 are repeated until either a terminal condition is met (determined at block 110) or until the cost metric for the (new) current allocation is not less than the cost metric for the stored best allocation (determined at block 120).

If the cost metric for the (new) current allocation is not less than the cost metric for the stored best allocation (which will typically be the case) (determined at block 134), the merge-filter heuristic is again applied (blocks 124-134). Thus, blocks 124-134 will continually repeat until either no changes are indicated in the merge plan or until the (new) current allocation has a lower cost metric than the stored best allocation.

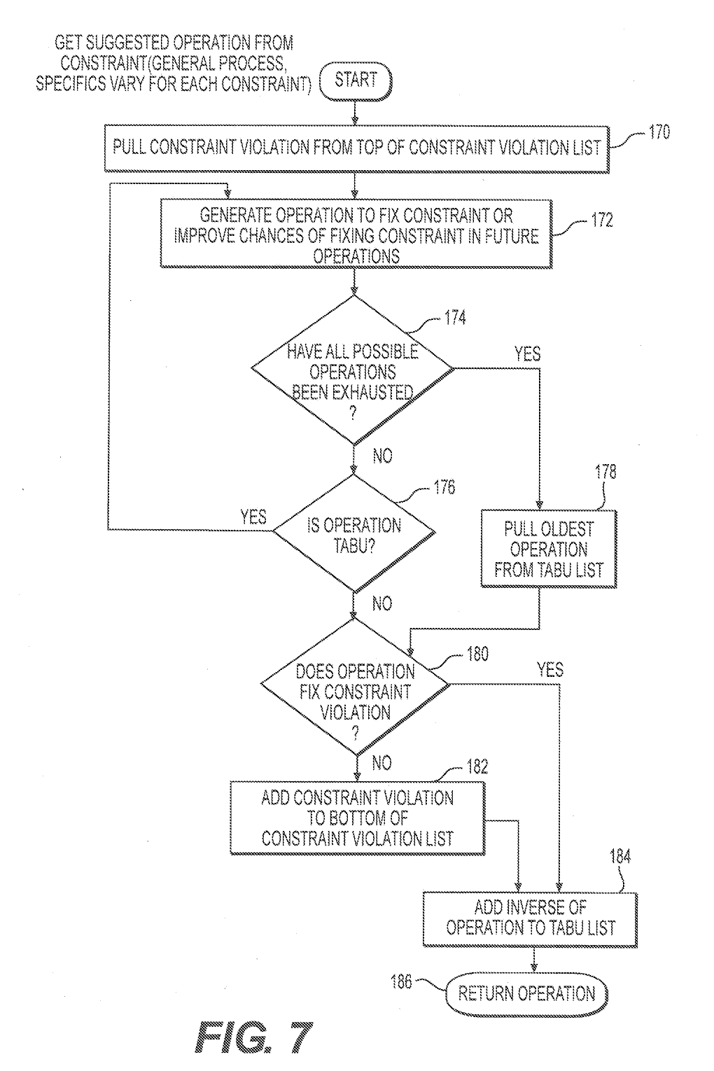

As mentioned above, the optimization process solves any identified constraint violations (at blocks 104, 116 and 130) by executing the “Solve Constraints” process illustrated in FIG. 6. Referring now to FIG. 6, the “Solve Constraints” process will be described in more detail. It is determined whether any constraint-violations exist (block 140). If constraint violations exist, the tabu list is emptied (block 142). The list of constraints is obtained (e.g., there may be three constraints—Resource Constraint, Space Compatibility, Consumer Compatibility) (block 144), and the next constraint in the list is obtained (block 146). If there are no constraints left on the list to try (block 148), the process starts at the top of the list again. If it is determined at block 148 that there are constraints left to try, it is then determined whether there are any constraint violations associated with the constraint currently being processed (block 150). If not, the next constraint on the list is processed (block 146). If the current constraint has violations, a suggested operation to solve the violation is obtained (block 152) by executing the “Get Suggested Operation from constraint” process illustrated in FIG. 7 (discussed in more detail below). Each constraint is able to suggest operations (moves or swaps) to solve its own local problem, but may not in general use any moves indicated on the tabu list. The list of violations is updated (by adding or removing violations as appropriate) (block 154) (each constraint is responsible for managing the elements of the list associated with it), and the operation suggested by the “Get Suggested Operation from Constraint” process is applied (block 156). The result of applying the suggested operation could be better or worse, but some progress will generally be made towards solving the current constraint violation. In addition, as illustrated in FIG. 7 (discussed below), the inverse of that operation will have been added to the tabu list, preventing the suggested operation from being undone by other constraints during subsequent evaluation. It is then determined whether there are any constraint violations at all remaining (block 158). If not, the “Solve Constraints” process ends. If there are still constraint violations remaining, the next constraint is processed (block 146). Blocks 144-158 are repeated until no constraint violations remain. Blocks 144-148 are structured to “rotate” through the different constraints when solving the constraint violations, rather than solving all violations for any one constraint before moving on to the next constraint.

When applying the inverse of the suggested, operation, a swap operation (in which two people's space allocations are swapped) is recorded in the tabu list as two individual move operations restoring each to his previous location. As stated above, the inverse of whatever operation is performed is added to the tabu list to prevent the reverse move from being suggested (at least not until all of the operations have been exhausted, as discussed below in relation to FIG. 7) and to prevent the solver from becoming stuck in a loop as it revisits the same allocation state repeatedly.

As mentioned above, the optimization process solves constraint violations by getting suggested operations (at block 152) from the “Get Suggested Operation from Constraint” process illustrated in FIG. 7. Note that each constraint has its own implementation of this process, since each will need a different approach to resolving violations. The process shown in FIG. 7 is general in nature and details will vary for each constraint. Referring now to FIG. 7, the “Get Suggested Operation from Constraint” process will be described in more detail. A constraint violation is pulled from the top of the list of constraint violations associated with this constraint (block 170). This list is in no particular order initially. Each constraint keeps its own list of violations associated with that constraint. An operation is generated to fix a constraint violation or improve the chances of fixing a constraint violation in the future (block 172). In one embodiment of the invention, each operation is either a move of one person from one space to a different space or a swap of two people into each other's space. Such an operation will typically not worsen the constraint's own total violations (i.e., will typically not increase the total number of violations for that constraint), but may make other constraints worse (i.e., may increase the total number of violations of another constraint). A suggested operation may not necessarily fix a violation, but may improve the chances of fixing a violation in the future. For example, moving one person out of a space that is overloaded by five people will not fix that overloading, but will improve the chances of fixing that overloading in the future.

It is then determined whether all operations have been exhausted (block 174). If not, it is determined whether the operation is tabu, by comparing the operation to the tabu list (block 176). If the operation is, tabu, another operation is generated at block 172. If the operation is not tabu, it is determined if the operation fixes the constraint violation (block, 180) (as mentioned above, the operation may not fix the violation, but may improve the chances of fixing the violation in the future). If it is determined at block 180 that the operation fixes the constraint violation, the inverse of the operation is added to the tabu list (block 184) (as discussed above) and the operation is returned to the “Solve Constraints” process to be applied (block 186). If it is determined at block 180 that the operation does not fix the constraint violation, the constraint violation is added to the bottom of the constraint violation list (block 182) so that the process will make further attempts to continue to resolve the constraint violation in the future. The inverse of the operation is then added to the tabu list (block 184) (as discussed above) and the operation is returned to the “Solve Constraints” process to be applied (block 186).

If it is determined at block 174 that all possible operations have been exhausted, the process then pulls the oldest operation from the tabu list (block 178). The purpose of performing the oldest operation in the tabu list is to undo an earlier decision that might be preventing a solution from being found. By choosing the oldest operations first (rather than the more recent ones), the chances of finding an improved solution are increased.

As mentioned above, the optimization process finds the most direct path to a lower cost space allocation (at blocks 106, 118 and 132) by executing the “Apply Greedy Heuristic” process illustrated in FIG. 8. The “Apply Greedy Heuristic” process iterates over every consumer, evaluating the possibility of moving the consumer into every other space and evaluating the possibility of swapping the consumer with every other consumer. Using a spatial tree search (described in more detail below), spaces closer to the consumer are analyzed before spaces further away from the consumer.

More specifically, the “Apply Greedy Heuristic” process (a) identifies a consumer; (b) identifies the closest space; (c) determines if moving the consumer into the identified space will reduce the consumer's cost metric; (d) if not, determines if swapping the consumer with the consumer in the identified space (or, one-at-a-time, swapping the consumer with each of the consumers in the identified space) will reduce the consumer's cost metric; and (e) if not, identify the next closest space and repeat the process. If it is determined either at (c) or (d) that the move or swap, respectively, will reduce the consumer's cost metric, then that move or swap is performed.

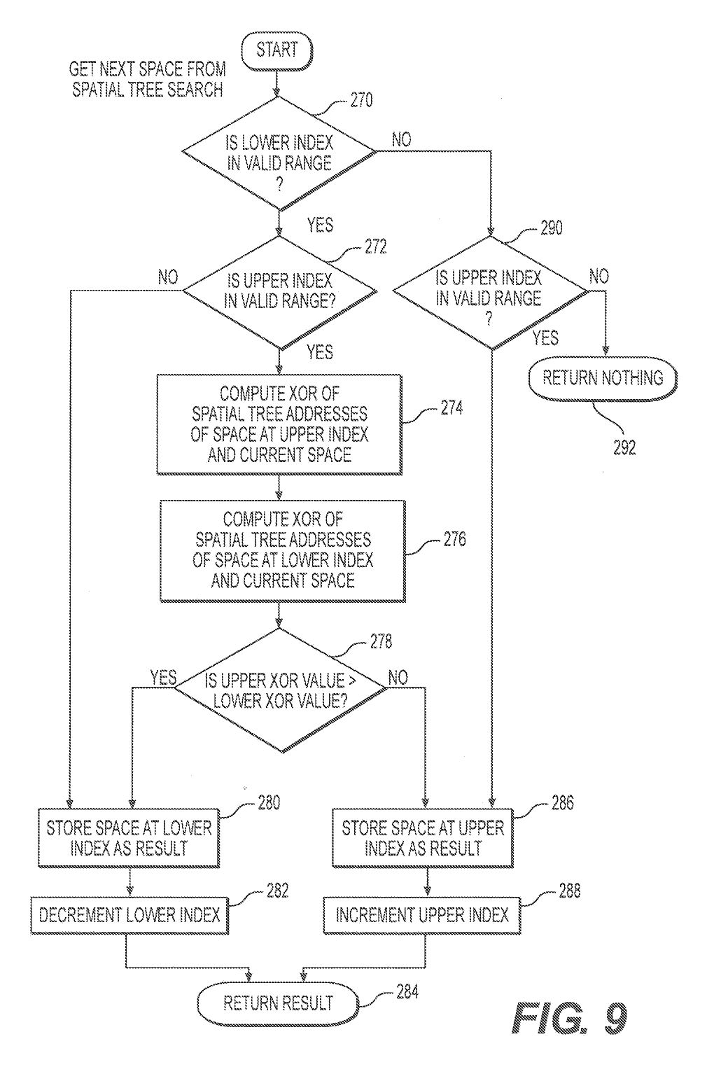

Referring now to FIG. 8, the “Apply Greedy Heuristic” process will be described in more detail. The priority queue of consumers is initialized, using the contribution metric as priority (block 200). This means that the list of consumers; sorted by declining metric cost, is obtained. The exhausted count is initialized to zero (block 202) to track how many consumers have been processed. It is then determined if the exhausted count is less than the consumer count (block 204) to determine if there are any consumers left to process. If there are consumers left to process, the next consumer on the priority list is pulled (block 206). The upper and lower spatial tree search indices are initialized (block 208). This indexes the addresses above and below the address of the current space (i.e., the space of the consumer being analyzed), in order to be able to methodically search all of the spaces in order of closest to farthest away from the current space. The next space is obtained (block 210) by executing the “Get Next Space from Spatial Tree Search” process illustrated in FIG. 9. This next space that is obtained is the next closest space into to which to try moving and swapping the current consumer.

It is then determined if there are any spaces left to try (block 212). This determines if the process had tried moving the current consumer to every other space and swapping the current consumer with every other consumer. If there are no spaces left to try for the current consumer, then the exhausted count is incremented (block 214), the current consumer's priority is set to zero (block 216) and the current consumer is put at the end of the priority queue (block 218). Then the process returns to block 204 to determine if there are any other consumers to analyze.

If it is determined at block 212 that there are spaces left to try for the current consumer, a new operation is defined that would move the current consumer into the new space (block 220). The new operation is evaluated for constraint violations (i.e., would moving the current consumer into the new space violate a constraint?) (block 222). If it is determined that the new operation would not cause a constraint violation (block 224), the new operation is evaluated to determine the metric change that would result from the operation (block 226). If it is determined that the new operation would result in a cost reduction. (i.e., metric change<0) (block 228), then the new operation is applied (block 230). Any time an operation is applied (either a move or a swap), the exhausted count is set to zero (block 232) such that the process starts all over again analyzing the consumers. The priority of the current consumer is updated (using the absolute value of the metric change divided by the number of operations tried before this cost reduction was obtained) (block 234) and the consumer is inserted back into the priority list based on this updated priority (block 236).

Blocks 238-252 of FIG. 8 are configured to try swapping the current consumer with the other consumers in the “new” space, if a move operation to the “new” space would either produce a constraint violation (determined at block 224) or would not produce a cost reduction (determined at block 228). First, the list of consumers in the new space is obtained (block 238), and the next consumer on the list is obtained (block 240). It is then determined if there are any consumers left to try in the new space (block 242). If there are no consumers left to try in the new space, then the next closest space is obtained (block 210) to try moving and swapping the current consumer. If there are consumers left to try, a new operation is defined to swap the current consumer with the consumer in the new space (block 244). This, operation is evaluated for constraint violations (i.e., would swapping the consumers violate a constraint?) (block 246). If it is determined that the new operation would not cause a constraint violation (block 248), the new operation is evaluated to determine the metric change that would result from the operation (block 250). If it is determined that the new operation would result in a cost reduction (i.e., metric change<0) (block 252), then the new operation is applied (block 230). As discussed above, any time an operation is applied (either a move or a swap), the exhausted count is set to zero (block 232) such that the process starts all over again analyzing the consumers. The priority of the current consumer is updated (using the absolute value of the metric change divided by the number of operations tried before this cost reduction was obtained) (block 234) and the consumer is inserted back into the priority list based on this updated priority (block 236).

If the swap operation either would produce a constraint violation (determined at block 248) or would not produce a cost reduction (determined at block 252), then the process evaluates the potential swapping of any other consumers in the new space until swaps with all consumers in the new space have been evaluated.

As discussed above, the “Apply Greedy Heuristic” process uses a spatial tree search to analyze spaces closer to the consumer before analyzing spaces further away from the consumer. Each space is assigned an address using a technique for creating a spatial tree. The addresses enable the spaces to be ordered and give an inherent hierarchy to compare addresses to decide which tree branch to investigate. One example technique used in embodiments of the invention is to continuously subdivide a space (such as a building or an entire facility), using alternating horizontal and vertical lines, until the centroid of each space is within its own subdivided space. There are many different techniques for determining where to place the subdividing lines. An address for each space may then be determined based on whether the centroid is above or below the first (horizontal) line, whether it is to the left or to the right of the next (vertical), line, whether it is above or below the next (horizontal) line, and so on. (This example presumes the subdividing begins with a horizontal line). Each space would ultimately be assigned an address of the form “D-R-U-L,” as an example, where “D” means that the centroid is below (“down”) the first (horizontal) line, “R” means that the centroid is to the right of the second (vertical) line, “U” means that the centroid is above (“up”) the third (horizontal) line, and “L” means that the centroid is to the left of the fourth (vertical) line. Such a spatial address (DRUL) may be converted to binary, for example using a key in which D=0, U=1, L=0, and R=1. In such an example, the spatial address “DRUL” is given a binary address of 0110. By converting the spatial address to binary, it becomes easier to compare addresses. The addresses are then sorted and stored in a list in binary order.

As mentioned above, the “Apply Greedy Heuristic” process obtains the next space (at block 210) by executing the “Get Next Space from Spatial Tree Search” process illustrated in FIG. 9. Referring now to FIG. 9, the “Get Next Space from Spatial Tree Search” process will be described in more detail. The“Apply Greedy Heuristic” process moves up and down the address list to analyze the effect of moving and swapping the current consumer into different space's, using the address list to first try addresses closest to the current consumer's current space. The “Get Next Space from Spatial Tree Search” process of FIG. 9 basically calculates differences between the binary value of the current space and the binary values of spaces on either side of the current space (above and below in the sorted list of addresses) to determine which of the other spaces is closest to the current space and returns that closest space to the “Apply Greedy Heuristic” process. First, the “Get Next Space from Spatial Tree Search” process determines if the lower index is in a valid range (block 270) and if the upper index is in a valid range (block 272 or block 290). If neither the upper index nor the lower index is in a valid range, then no result is returned to the “Apply Greedy Heuristic” process (block 292). If the lower index is within a valid range (determined at block 270) but the upper index is not (determined at block 272), then the “Get Next Space from Spatial Tree Search” process stores the space that is at the lower index as the result (block 280), decrements the lower index (block 282), and returns the result to the “Apply Greedy Heuristic” process (block 284).

If the lower index is within a valid range (determined at block 270) and the upper index is also within a valid range (determined at block 272), then the “Get Next'Space from Spatial Tree Search” process computes an XOR of the spatial tree addresses of the space at the upper index and the current space (block 274). The“Get Next Space from Spatial Tree Search” process also computes an XOR of the spatial tree addresses of the space at the lower index and the current space (block 276). If the upper XOR value is greater than the lower XOR value (i.e., the upper space is further away from the current space than is the lower space), then the process stores the space that is at the lower index as the result (block 280), decrements the lower index (block 282), and returns the result to the “Apply Greedy Heuristic” process (block 284). If the upper XOR value is not greater than the lower XOR value (i.e., the upper space is closer to the current space than is the lower space), then the process stores the space that is at the upper index as the result (block 286), increments the upper index (block 288), and returns the result to the “Apply Greedy Heuristic” process (block 284).

As mentioned above, the merge-filter heuristic of the main optimization program sets everyone's allocation as coming from the current allocation. However, if both the current and best allocations for a particular person use the same space, then that person's allocation is set as coming from the best allocation. This is performed in the “Initialize Merge Plan” process illustrated in FIG. 10. Referring now to FIG. 10, the “Initialize Merge Plan” process will be described in more detail. The “Initialize Merge Plan” process initially sets the spaces for all consumers as coming from the current allocation (block 300). The list of consumers is then obtained (block 302). Iterating through blocks 304 and 306 causes the process to check each consumer until all consumers have been checked. For each consumer, it is determined if the allocated space in the current allocation is the same as in the best allocation (block 308). If so, the plan is changed to show the current consumer's space allocation as coming from the best allocation (block 310). If not, no change is made and the next consumer is checked.

As mentioned above, the merge-filter heuristic of the main optimization program changes a person's allocation from “current” to “best” if the “best” allocation for that person has a lower cost metric. This is performed in the “Filter Merge Plan” process illustrated in FIG. 11. Referring now to FIG. 11, the “Filter Merge Plan” process will be described in more detail. The “Filter Merge Plan” process obtains the list of consumers (block 320). Iterating through blocks 322 and 324 causes the process to check each consumer until all consumers have been checked. For each consumer, it is determined if the consumer's space was taken from the best allocation (block 326). If so, the next consumer is checked. If not, it is determined if the consumer's cost metric in the current allocation is less than that of the best allocation (block 328). If so, the next consumer is checked. If not, the merge plan is changed to take the consumer's space from the best allocation (block 330). The “Filter Merge Plan” process only changes a consumer's space allocation from the current allocation to the best allocation and not vice versa.

The following illustrates the benefits of large-scale optimization at a complex Government facility. The combined metrics for the current facility space allocation produces a value around $25 million. By applying the greedy heuristic alone, requiring just a couple of minutes, the resulting allocation has a combined metric of $15 million. If the combination of the weedy heuristic and the merge-filer heuristic is run over about 24 hours, the resulting solution is approximately $11 million and the rate of improvement is generally very low after that.

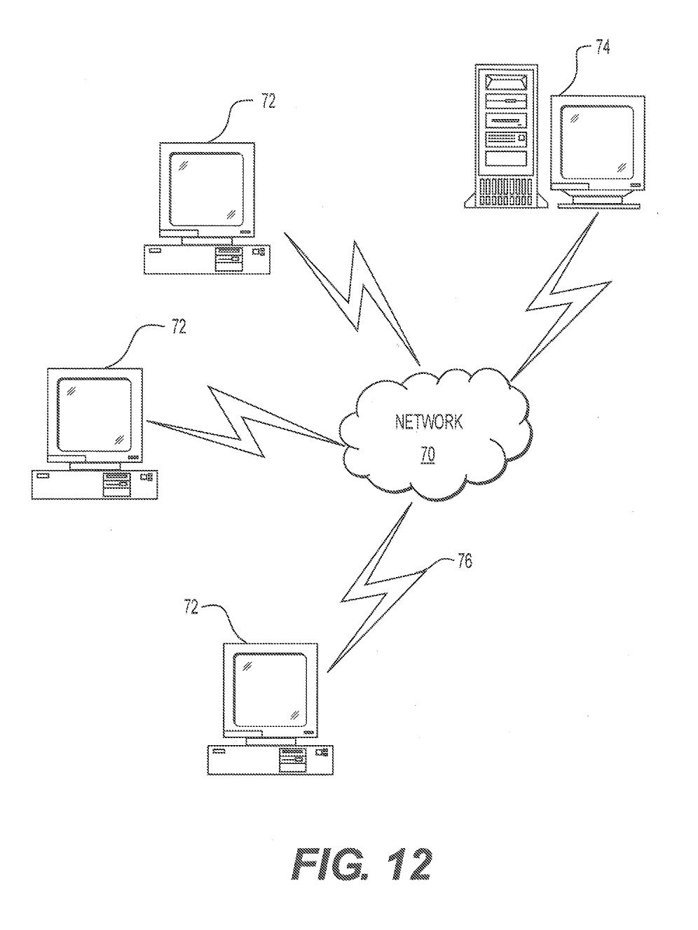

FIG. 12 is a schematic block diagram of a computer network in which embodiments of the present invention may operate. Computers 72 and server 74 provide processing, storage, and input/output devices executing application programs and the like. Computers 72 may be linked over communication link 76 through communications network 70 to each other and to other computing devices, including server 74. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72 and server 74 may be linked over any suitable communication network.

In addition to the client-server arrangement of FIG. 12, embodiments of the invention may operate in any client-server arrangement or in any networked arrangement in which resources to be updated and tasks to perform the updating may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

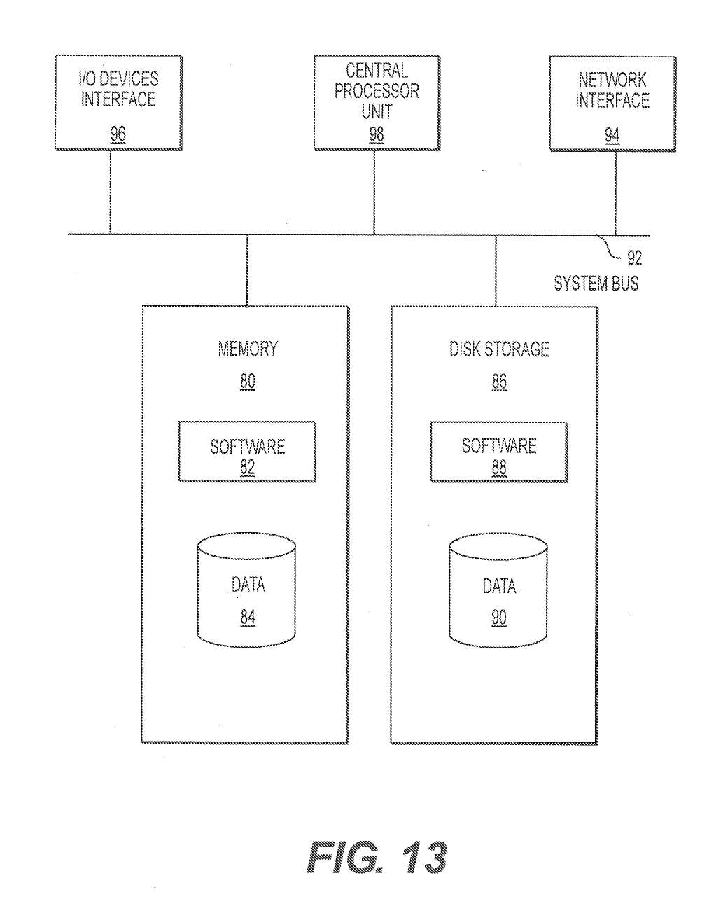

FIG. 13 is a diagram of one possible internal structure of a computer (e.g., computer 72) in the system of FIG. 12. Each computer typically contains system bus 92, where a bus is a set of hardware lines used for data transfer among the components of a computer. Bus 92 is essentially a shared conduit that connects different elements of a computer system (e.g., processor, disk storage, memory, input/output ports, network ports, etc.) that enables the transfer of information between the elements. Attached to system bus 92 is I/O devices interface 96 for connecting various input and output devices (e.g., displays, printers, speakers, microphones, etc.) to the computer. Alternatively, the I/O devices may be connected via one or more I/O processors attached to system bus 92. Network interface 94 allows the computer to connect to various other devices attached to a network (e.g., network 70 of FIG. 3). Memory 80 provides volatile storage for computer software instructions 82 and data 84 used to implement an embodiment of the present invention. Disk storage 86 provides non-volatile storage for computer software instructions 88 and data 90 used to implement an embodiment of the present invention. Central processor unit 98 is also attached to system bus 92 and provides for the execution of computer instructions.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program; and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. The embodiments were chosen and described in order to best explain the principles of the invention and the practical application, and to enable others of ordinary skill in the art to understand the invention for various embodiments with various modifications as are suited to the particular use contemplated. While the best modes for carrying out the invention have been described in detail, those familiar with the art to which this invention relates will recognize various alternative designs and embodiments for practicing the invention within the scope of the appended claims.

1. A computer-implemented method for generating a spatially constrained tree map diagram, the method comprising:
(i) organizing features from a data set into a binary tree representation comprising a plurality of nodes, each node being either (a) a leaf node representing a feature in a lowest level data set or (b) a non-leaf node containing a reference to two child nodes, a top-most node having a definition of a convex polygon that will contain the entire spatial tree map diagram, each node containing a quantity to be represented by an area of a corresponding polygon and for non-leaf nodes this quantity being the sum of the two contained child nodes, each node further containing a direction in which that node's polygon should be split by a straight line to generate polygons for the child nodes, each non-leaf node being constrained such that the set of spatial features corresponding to a sub-tree rooted at that node can be split into two groups using a single line oriented in a similar direction to the line used to split the node's polygon in the diagram and such that these two groups correspond to the sub-trees rooted at each of the child nodes;
(ii) starting at the top-most node and recursively processing each of the child nodes in turn by:
(a) for each non-leaf node, generating two polygons by cutting the original polygon along the direction indicated such that the ratio of the areas of the two generated polygons is the same as the ratio of the quantitative metric stored in the child nodes; and
(b) storing each generated polygon in the corresponding child node; and
(iii) reading the generated polygons at each node from the tree.

2. The method of claim 1, wherein the direction in which each node's polygon should be split is either along a vertical or a horizontal direction.

3. The method of claim 1, wherein the direction in which each node's polygon should be split and/or the location of the split is selected to maximize the gap distance between the closest features associated with the child nodes of a particular node.

4. The method of claim 1, wherein the direction in which each node's polygon should be split and/or the location of the split is selected to balance the total metric quantities in each child node of a particular node.

5. The method of claim 1, wherein the direction in which each node's polygon should be split and/or the location of the split is selected to balance the center of mass of the child nodes' associated spatial features along a direction opposite to the splitting direction defined for the parent node.

6. The method of claim 1, wherein the direction in which each node's polygon should be split and/or the location of the split is selected to generate a polygon having a reduced aspect.

7. The method of claim 1, wherein features from a data set are organized into a binary tree representation using (i) a top-down recursive generation method, (ii) a top-down recursive generation method with back tracking, (iii) a bottom-up generation method comprising construction of sub-trees based on proximity based clustering, (iv) a random construction method, or any of (i), (ii), (iii), or (iv) combined with one or more optimization techniques.

8. A computer program product for generating a spatially constrained tree map diagram, the computer program product comprising a computer readable storage medium having computer readable program code embodied therewith, the computer readable program code comprising:
(i) computer readable program code configured for organizing features from a data set into a binary tree representation comprising a plurality of nodes, each node being either (a) a leaf node representing a feature in a lowest level data set or (b) a non-leaf node containing a reference to two child nodes, a top-most node having a definition of a convex polygon that will contain the entire spatial tree map diagram, each node containing a quantity to be represented by an area of a corresponding polygon and for non-leaf nodes this quantity being the sum of the two contained child nodes, each node further containing a direction in which that node's polygon should be split by a straight line to generate polygons for the child nodes, each non-leaf node being constrained such that the set of spatial features corresponding to a sub-tree rooted at that node can be split into two groups using a single line oriented in a similar direction to the line used to split the node's polygon in the diagram and such that these two groups correspond to the sub-trees rooted at each of the child nodes;
(ii) computer readable program code configured for starting at the top-most node and recursively processing each of the child nodes in turn by:
(a) for each non-leaf node, generating two polygons by cutting the original polygon along the direction indicated such that the ratio of the areas of the two generated polygons is the same as the ratio of the quantitative metric stored in the child nodes; and
(b) storing each generated polygon in the corresponding child node; and
(iii) computer readable program code configured for reading the generated polygons at each node from the tree.

9. The computer program product of claim 8, wherein the direction in which each node's polygon should be split is either along a vertical or a horizontal direction.

10. The computer program product of claim 8, wherein the direction in which each node's polygon should be split and/or the location of the split is selected to maximize the gap distance between the closest features associated with the child nodes of a particular node.

11. The computer program product of claim 8, wherein the direction in which each node's polygon should be split and/or the location of the split is selected to balance the total metric quantities in each child node of a particular node.

12. The computer program product of claim 8, wherein the direction in which each node's polygon should be split and/or the location of the split is selected to balance the center of mass of the child nodes' associated spatial features along a direction opposite to the splitting direction defined for the parent node.

13. The computer program product of claim 8, wherein the direction in which each node's polygon should be split and/or the location of the split is selected to generate a polygon having a reduced aspect.

14. The computer program product of claim 8, wherein features from a data set are organized into a binary tree representation using (i) a top-down recursive generation method, (ii) a top-down recursive generation method with back tracking, (iii) a bottom-up generation method comprising construction of sub-trees based on proximity based clustering, (iv) a random construction method, or any, of (i), (ii), (iii), or (iv) combined with one or more optimization techniques.

15. A method of space optimization comprising:
(a) obtaining a current space allocation;
(b) solving the current space allocation for constraint violations;
(c) applying a greedy heuristic to the current space allocation to obtain a first lower cost space allocation without violating any constraints;
(d) saving the first lower cost space allocation as a best space allocation;
(e) generating a first random space allocation;
(f) saving the first random space allocation as the current space allocation;
(g) solving the first random space allocation for constraint violations;
(h) applying a greedy heuristic to the first random space allocation to obtain a second lower cost space allocation without violating any constraints;
(i) comparing a cost of the second lower cost space allocation to a cost of the best space allocation; and
(j) if the cost of the second lower cost space allocation is less than the cost of the best space allocation, saving the second lower cost space allocation as the best space allocation.

16. The method of claim 15, further comprising:
if the cost of the second lower cost space allocation is not less than the cost of the best space allocation:
(k) generating a second random space allocation;
(l) saving the second random space allocation as the current space allocation;
(m) solving the second random space allocation for constraint violations;
(n) applying a greedy heuristic to the second random space allocation to obtain a third lower cost space allocation without violating any constraints;
(o) comparing a cost of the third lower cost space allocation to a cost of the best space allocation; and
(p) if the cost of the third lower cost space allocation is less than the cost of the best space allocation, saving the third lower cost space allocation as the best space allocation.

17. The method of claim 15, further comprising:
if the cost of the second lower cost space allocation is not less than the cost of the best space allocation:
(k) comparing, for each consumer of a space, a cost allocation from the best space allocation to a cost allocation from the second lower cost space allocation to determine a lower cost space allocation for each consumer;
(l) merging the lower cost space allocations for each consumer and saving the lower cost space allocations for each consumer as the current space allocation;
(m) solving the current space allocation for constraint violations;
(n) applying a greedy heuristic to the current space allocation to obtain a third lower cost space allocation without violating any constraints;
(o) comparing a cost of the third lower cost space allocation to a cost of the best space allocation; and
(p) if the cost of the third lower cost space allocation is less than the cost of the best space allocation, saving the third lower cost space allocation as the best space allocation.

18. The method of claim 17, further comprising:
if the cost of the third lower cost space allocation is not less than the cost of the best space allocation:
(q) comparing, for each consumer of a space, a cost allocation from the best space allocation to a cost allocation from the third lower cost space allocation to determine a lower cost space allocation for each consumer;
(r) merging the lower cost space allocations for each consumer and saving the lower cost space allocations for each consumer as the current space allocation;
(s) solving the current space allocation for constraint violations;
(t) applying a greedy heuristic to the current space allocation to obtain a fourth lower cost space allocation without violating any constraints;
(u) comparing a cost of the fourth lower cost space allocation to a cost of the best space allocation; and
(v) if the cost of the fourth lower cost space allocation is less than the cost of the best space allocation, saving the fourth lower cost space allocation as the best space allocation.

19. The method of claim 15, wherein applying the greedy heuristic comprises:
(i) identifying a current consumer;
(ii) identifying a space closest to the current consumer;
(iii) determining if moving the current consumer into the identified space will reduce a cost metric of the current consumer;
(iv) if moving the current consumer into the identified space will reduce a cost metric of the current consumer, moving the current consumer into the identified space;
(v) if moving the current consumer into the identified space will not reduce a cost metric of the current consumer, determining if swapping the current consumer with a consumer in the identified space will reduce the cost metric of the current consumer;
(Vi) if swapping the current consumer with a consumer in the identified space will reduce the cost metric of the current consumer, swapping the current consumer with a consumer in the identified space; and
(vii) if swapping the current consumer with a consumer in the identified space will not reduce the cost metric of the current consumer, identifying a next-closest space to the current consumer and repeating steps (iii) to (vi) for the next-closest space.

20. A computer program product for space optimization, the computer program product comprising a computer readable storage medium having computer readable program code embodied therewith, the computer readable program code comprising:
(a) computer readable program code configured for obtaining a current space allocation;
(b) computer readable program code configured for solving the current space allocation for constraint violations;
(c) computer readable program code configured for applying a greedy heuristic to the current space allocation to obtain a first lower cost space allocation without violating any constraints;
(d) computer readable program code configured for saving the first lower cost space allocation as a best space allocation;
(e) computer readable program code configured for generating a first random space allocation;
(f) computer readable program code configured for saving the first random space allocation as the current space allocation;
(g) computer readable program code configured for solving the first random space allocation for constraint violations;
(h) computer readable program code configured for applying a greedy heuristic to the first random space allocation to obtain a second lower cost space allocation without violating any constraints;
(i) computer readable program code configured for comparing a cost of the second lower cost space allocation to a cost of the best space allocation; and
(j) computer readable program code configured for, if the cost of the second lower cost space allocation is less than the cost of the best space allocation, saving the second lower cost space allocation as the best space allocation.

21. The computer program product of claim 20, further comprising:
computer readable program code configured for, if the cost of the second lower cost space allocation is not less than the cost of the best space allocation, performing the following steps:
(k) generating a second random space allocation;
(l) saving the second random space allocation as the current space allocation;
(m) solving the second random space allocation for constraint violations;
(n) applying a greedy heuristic to the second random space allocation to obtain a third lower cost space allocation without violating any constraints;
(o) comparing a cost of the third lower cost space allocation to a cost of the best space allocation; and
(p) if the cost of the third lower cost space allocation is less than the cost of the best space allocation, saving the third lower cost space allocation as the best space allocation.

22. The computer program product of claim 20, further comprising:
computer readable program code configured for, if the cost of the second lower cost space allocation is not less than the cost of the best space allocation, performing the following steps:
(k) comparing, for each consumer of a space, a cost allocation from the best space allocation to a cost allocation from the second lower cost space allocation to determine a lower cost space allocation for each consumer;
(l) merging the lower cost space allocations for each consumer and saving the lower cost space allocations for each consumer as the current space allocation;
(m) solving the current space allocation for constraint violations;
(n) applying a greedy heuristic to the current space allocation to obtain a third lower cost space allocation without violating any constraints;
(o) comparing a cost of the third lower cost space allocation to a cost of the best space allocation; and
(p) if the cost of the third lower cost space allocation is less than the cost of the best space allocation, saving the third lower cost space allocation as the best space allocation.

23. The computer program product of claim 22, further comprising:
computer readable program code configured for, if the cost of the third lower cost space allocation is not less than the cost of the best space allocation, performing the following steps:
(q) comparing, for each consumer of a space, a cost allocation from the best space allocation to a cost allocation from the third lower cost space allocation to determine a lower cost space allocation for each consumer;
(r) merging the lower cost space allocations for each consumer and saving the lower cost space allocations for each consumer as the current space allocation;
(s) solving the current space allocation for constraint violations;
(t) applying a greedy heuristic to the current space allocation to obtain a fourth lower cost space allocation without violating any constraints;
(u) comparing a cost of the fourth lower cost space allocation to a cost of the best space allocation; and
(v) if the cost of the fourth lower cost space allocation is less than the cost of the best space allocation, saving the fourth lower cost space allocation as the best space allocation.

24. The computer program product of claim 20, wherein the computer readable program code configured for applying the greedy heuristic comprises:
(i) computer readable program code configured for identifying a current consumer;
(ii) computer readable program code configured for identifying a space closest to the current consumer;
(iii) computer readable program code configured for determining if moving the current consumer into the identified space will reduce a cost metric of the current consumer;
(iv) computer readable program code configured for, if moving the current consumer into the identified space will reduce a cost metric of the current consumer, moving the current consumer into the identified space;
(v) computer readable program code configured for, if moving the current consumer into the identified space will not reduce a cost metric of the current consumer, determining if swapping the current consumer with a consumer in the identified space will reduce the cost metric of the current consumer;
(vi) computer readable program code configured for, if swapping the current consumer with a consumer in the identified space will reduce the cost metric of the current consumer, swapping the current consumer with a consumer in the identified space; and
(vii) computer readable program code configured for, if swapping the current consumer with a consumer in the identified space will not reduce the cost metric of the current consumer, identifying a next-closest space to the current consumer and repeating steps (iii) to (vi) for the next-closest space.
